(19) United States
(12) Patent Application Publication
(10) Pub. No.: US 2019/0375035 A1
(43) Pub. Date: Dec. 12, 2019

(54) FLANGE GASKET SCRAPER TOOL

(71) Applicants: ADRIAN CHAVEZ, JR., WESLACO, TX (US); ARMANDO RAMIREZ, ALAMO, TX (US)

(72) Inventors: ADRIAN CHAVEZ, JR., WESLACO, TX (US); ARMANDO RAMIREZ, ALAMO, TX (US)

(21) Appl. No.: 16/004,342

(22) Filed: Jun. 9, 2018

(51) Int. Cl. B23D 79/08

(52) U.S. Cl. CPC B23D 79/08

(57) ABSTRACT

A flange gasket scraper tool includes a handle, and flexible shaft extending from the handle, one or more scraping elements and a removal member. The scraping elements extend outward from the shaft or are located at a distance away from a central axis of the shaft. The removal member is coupled to the shaft and extends back towards the handle. The scraper body may have either a rectangular profile or a triangular profile. The scraper blades are configured with an edge treatment and may be tapered or squared at the edges. In one embodiment the scraper blade, the shaft, and the removal member are in the same plane. The tools are used to enter into and scrape out used gaskets from an area at the end of pipes.

### BACKGROUND

### 1. Field of the Invention

The present application relates to a tool to remove a seal or gasket, and more particularly to a removal and scraper tool to remove flange gaskets between pipes.

### 2. Description of Related Art

Abutting pipe together may be done in different ways depending on the industry and the pressures within the pipe. For small applications with little pressure, fittings may be used as seen with small plumbing applications. In a larger scale where pressures increase and the overall volume transmitted are fairly large, pipes include flanges at the ends which have a number of holes. Abutted pipes are fastened together through the holes and torqued to proper levels. In order to seal the pipes, a flange gasket is located between the pipe ends. Typically the end of each pipe includes a protruding ring adjacent the hollowed center for the flange gasket to seat on. The gasket is sandwiched between these protruding rings. Over time this flange gasket needs to be replaced, due to a leak or due to age for example. Removing and replacing used gaskets from flanged piping systems can pose a number of challenges, including accessibility and difficulty in separating the flanges.

The removal process includes removal of necessary flange fasteners. The flanges are carefully separated or opened using a special spreading tool or wedges. Once spread, the gasket is exposed. The issue that arises is with flange gasket removal is that the wedges and spreading tools can only space or open the pipes so much. Very little space is available to work between the flanges of the pipes. What increases the difficulty is the fact that gaskets are difficult to grasp or reach and pull from such a small gap. Also to reach and remove any residue or old gasket from the flange surfaces. If the old flange gasket is not fully removed, the new flange gasket will not seal properly.

Due to these complications, traditional scrapers are not very effective. Typically common place tools are used to scrape the surface of the flanges. These tools are not specialized for the task. Often they have generally cylindrical shafts with a single flat edge. The thicker the shafts, the less maneuvering there is. Some more intricate scraper tools have been used but they tend to use a blade of a singular width and any hooks or loops are made within the interior of the scraper blade width. Other items used can be pieces of wire or even knives. Whatever tool is used, it should be long enough to prevent the insertion of hands and fingers between the pipes. Which can cause hand injury. Safety concerns have led some to resort to using an aerosol removers and other techniques.

Although strides have been made to provide make the removal of pipe flange gaskets possible, shortcomings remain. It is desired that a tool be provided that minimizes shaft thickness, increases flexibility, and provides for multiple scraping surfaces outside the width of the shaft.

### SUMMARY OF THE INVENTION

It is an object of the present application to provide a flange gasket scraper tool that includes a handle, and flexible shaft extending from the handle, and one or more scraping elements, and a removal member. The scraping elements are in communication with the shaft and may extend outward from the shaft and be located at a distance away from a central axis. The removal member is curved away from the central shaft. In one embodiment, the scraper body and the removal member are integrally formed together. The scraper body is wider than the shaft and locates the removal member distal from the shaft. The shaft, scraper body, and the removal member are in the same plane.

Ultimately the invention may take many embodiments but features a shaft configured to flex about the long width of the shaft. The scraping elements are configured to extend outward beyond the shaft width to permit access to reach inside the small gap between the pipe ends as the tool is rotated when the pipes are separated. In this way, this tool overcomes the disadvantages inherent in the prior art.

The more important features of the tool have thus been outlined in order that the more detailed description that follows may be better understood and to ensure that the present contribution to the art is appreciated. Additional features of the tool will be described hereinafter and will form the subject matter of the claims that follow.

Many objects of the present tool will appear from the following description and appended claims, reference being made to the accompanying drawings forming a part of this specification wherein like reference characters designate corresponding parts in the several views.

Before explaining at least one embodiment of the tool in detail, it is to be understood that the assembly is not limited in its application to the details of construction and the arrangements of the components set forth in the following description or illustrated in the drawings. The tool is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and features for carrying out the various purposes of the present tool. It is important, therefore, that the claims be regarded as including such equivalent constructions insofar as they do not depart from the spirit and scope of the present tool.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a flange gasket scraper tool according to an embodiment of the present application.

FIG. 2 is a front view of the flange gasket scraper tool of FIG. 1.

FIG. 3 is a side view of the flange gasket scraper tool of FIG. 1.

FIG. 4 is a perspective view of an alternate embodiment of the flange gasket scraper tool of FIG. 1.

FIG. 5 is a front view of the flange gasket scraper tool of FIG. 4.

FIG. 6 is a side view of the flange gasket scraper tool of FIG. 4.

FIG. 7 is a side section view of a pipe connection and gasket to engage with the flange gasket scraper tool of FIG. 1.

FIG. 8 is a perspective view of an alternate embodiment of the flange gasket scraper tool of FIGS. 1 and 4.

FIG. 9 is a front view of the flange gasket scraper tool of FIG. 8.

FIG. 10 is a side view of the flange gasket scraper tool of FIG. 8.

While the tool and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of features as the tool is depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the assembly described herein may be oriented in any desired direction.

The tool and method in accordance with the present application overcomes one or more of the above-discussed problems commonly associated with existing scraping tools and techniques. In particular, the tool is configured to easily simplify the removal of a flange gasket from piping. The tool is configured to include a removal member configured to hook the flange gasket and pull it from between the pipe ends. The tool is also configured to having one or more scraping surfaces. These and other unique features of the assembly are discussed below and illustrated in the accompanying drawings.

The tool and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The tool and method of the present application is illustrated in the associated drawings. The tool includes a handle and a shaft. The shaft has a first end and a second end wherein the first end is coupled to the handle. The shaft is configured to flex about its width. A scraper body is coupled to the second end of the shaft. The scraper body includes at least one scraper blade along a top surface of the scraper body. A removal tool is included and runs parallel to the shaft to form a slot for the passage of the flange gasket. Additional features and functions of the device are illustrated and discussed below.

Referring now to the Figures wherein like reference characters identify corresponding or similar elements in form and function throughout the several views. The following Figures describe the tool of the present application and its associated features. With reference now to the Figures, an embodiment of a flange scraper gasket scraper tool is herein described. It should be noted that the articles “a”, “an”, and “the”, as used in this specification, include plural referents unless the content clearly dictates otherwise.

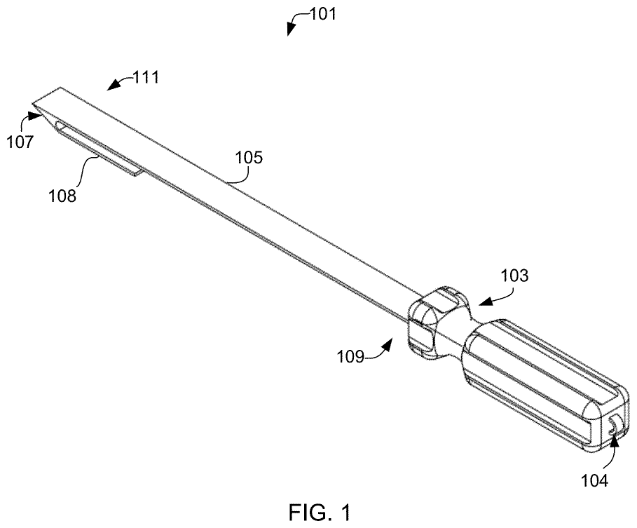

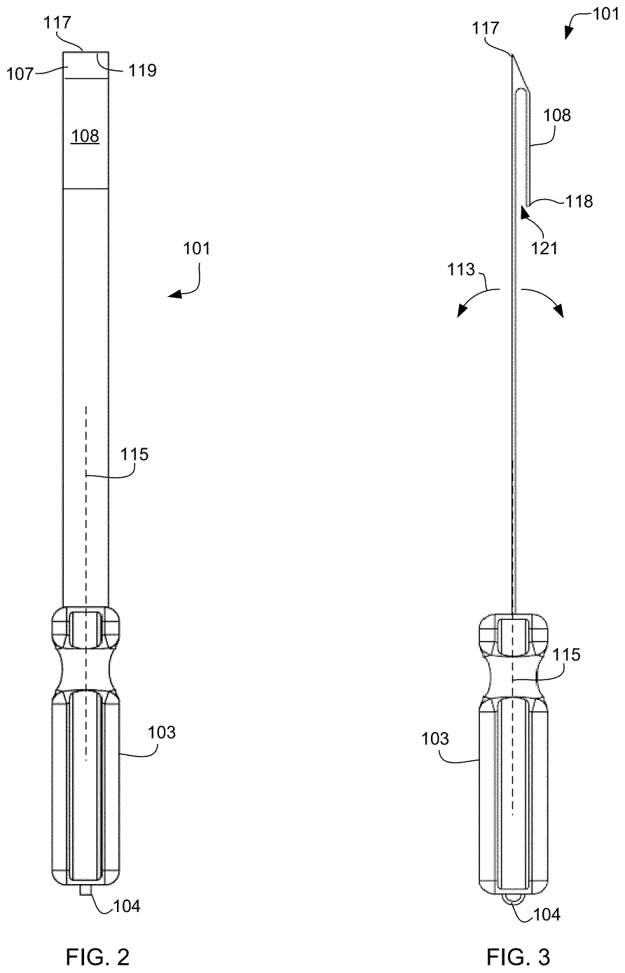

Referring now to FIGS. 1-3 in the drawings, views of a flange gasket scraper tool are illustrated. Flange gasket scraper tool 101 is shown in a perspective view in FIG. 1 and in a front and side view in FIGS. 2 and 3. Tool 101 is configured to extend between pipe flanges when separated to capture and remove old flange gaskets as well as scrape off residual flange gaskets so as to permit for the installation of a new flange gasket. The tool is configured to have a scraper body and one or more scraper blades. As seen in the Figures, tool 101 includes a handle 103, a shaft 105, a scraper body 107, and a removal member 108.

Handle 103 is configured to provide a user a place to grip and position scraper body 107 and removal member 108. Handle 103 is configured to include any one of a number of grips, grooves, curves, and textures to increase comfort and control of the tool in general. Handle 103 may be made from any known material and is configured to support shaft 105. Shaft 105 includes a first end 109 and a second end 111. First end 109 is coupled to handle 103. The second end 111 is adjacent to scraper body 107 and removal member 108. As seen in the figures, shaft 105 includes a narrowed section that is generally rectangular in shape, such that it has a thickness and a width. The thickness is smaller than the width. The drastic difference in the width compared to the thickness allows shaft 105 to flex about its width as seen in arrows 113 of FIG. 3, such that shaft 105 bends relative to a central axis 115. This flexure helps the user locate various surfaces within the pipe. It is understood that shaft 105 may include multiple contours and shapes along its length. It is preferred that shaft 105 include at least one area that allows flexure such that scraper body 107 and removal member 108 can alter its orientation relative to handle 103 during use.

Handle 103 also includes an eyelet 104 located on an end opposite that of shaft 105. Eyelet 104 is configured to permit a user to pass an object between itself and a bottom surface of handle 103 to enable tool 101 to be secured to a person or object. For example, a lanyard may pass there through to secure the tool 101 to a user. Any object may pass through eyelet 104 as long as it is sized accordingly.

Scraper body 107 is formed at the tip of shaft 105 along an edge 119. As seen in FIG. 3, body 107 has a generally triangular shape. This triangular shape helps to define the blade of body 107 and connect removal member 108 to shaft 105. Body 107 includes a width and a thickness similar to that of shaft 105. The width of body 107 extends in the same planar direction of shaft 105. The width being equal to that of shaft 105 and is sized such that the width of body 107 is within the width of handle 103. Body 107 is coupled to the second end 111 of shaft 105 and may have a thickness larger than the thickness of shaft 105 in some embodiments. Scraper body 107 includes a scraper blade 117 along top edge 119. As seen in the figures, blade 117 is tapered (see FIGS. 1 and 3) such that the thickness of blade 117 increases as it extends from edge 119 toward removal member 108. In this embodiment, blade 117 extends the full width of body 107.

It is understood that the material composition of scraper blade 117 may be the same or dissimilar to that of body 107. Additionally, the material composition of body 107 may be similar to or dissimilar from that of shaft 105. Whereas shaft 105 is designed and shaped to permit flexure to some extent, body 107 and blade 117 are configured to resist flexure. The flexure of shaft 105 can help with the prevention of marring of the pipe flange gasket surfaces. It is understood that blade 117 could be a coating or inlaid material across body 107 or within portions of body 107. Body 107 may include one or more blades along other edges and surfaces as desired. Such blades are similar in form and function to blade 117.

As seen most clearly in FIG. 3, removal member 108 is configured to extend out and away from shaft 105 and run parallel thereto. It is directed back toward handle 103 to permit a user to insert tool 101 into the gap 121 between the pipes, hook the gasket, and pull back so as to pull the gasket out. The gasket is to pass between the slot between shaft 105 and removal member 108. Member 108 may be made from the same material and have the same corresponding width and thickness as seen in the figures. It is understood that the thickness and width may differ from shaft 105 as desired. Also, the tip 118 of member 108 may be contoured with a curvature as opposed to the block rectangular shape.

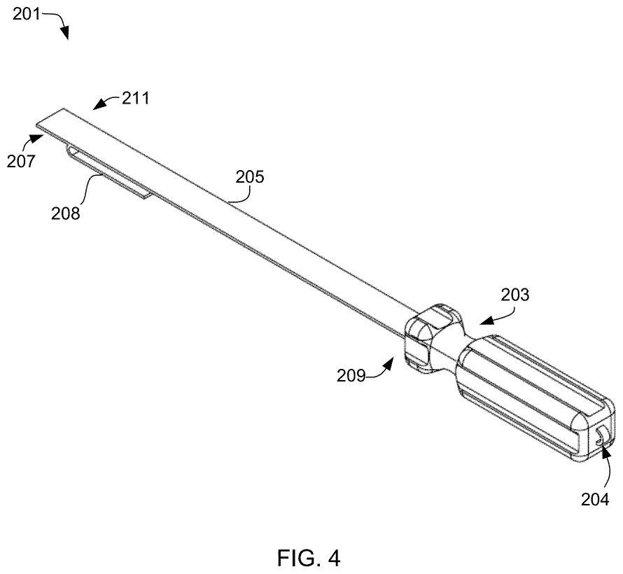

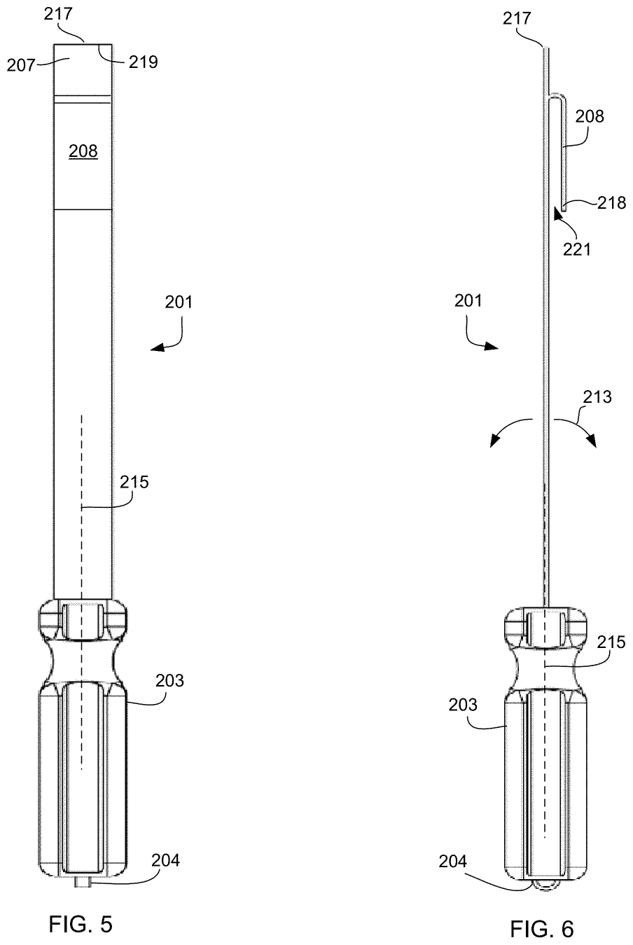

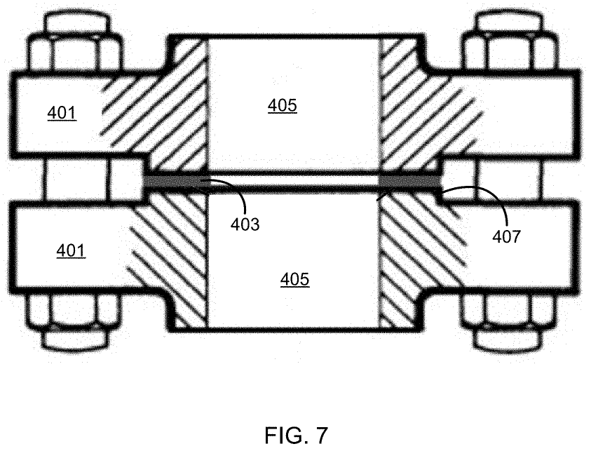

Referring now also to FIGS. 4-6 in the drawings, views of an alternate embodiment of tool 101 is illustrated. Flange gasket scraper tool 201 is similar in form and function to that of tool 101. FIG. 4 shows a perspective view of tool 201 while FIGS. 5 and 6 show a front and side view respectively. Although tool 201 is labeled an alternate embodiment, tool 201 has only a minor difference with respect to body 207. Tool 201 includes a handle 203, a shaft 205, a scraper body 207, and a removal member 208.

Handle 203 is configured to provide a user a place to grip and position scraper body 207 and removal member 208. Handle 203 is configured to include any one of a number of grips, grooves, curves, and textures to increase comfort and control of the tool in general. Handle 203 may be made from any known material and is configured to support shaft 205. Shaft 205 includes a first end 209 and a second end 211. First end 209 is coupled to handle 203. The second end 211 is adjacent to scraper body 207 and removal member 208. As seen in the figures, shaft 205 includes a narrowed section that is generally rectangular in shape, such that it has a thickness and a width. The thickness is smaller than the width. The drastic difference in the width compared to the thickness allows shaft 205 to flex about its width as seen in arrows 213 of FIG. 6, such that shaft 205 bends relative to a central axis 215. This flexure helps the user locate various surfaces within the pipe. It is understood that shaft 205 may include multiple contours and shapes along its length. It is preferred that shaft 205 include at least one area that allows flexure such that scraper body 207 and removal member 208 can alter its orientation relative to handle 203 during use.

Handle 203 also includes an eyelet 204 located on an end opposite that of shaft 205. Eyelet 204 is configured to permit a user to pass an object between itself and a bottom surface of handle 203 to enable tool 201 to be secured to a person or object. For example, a lanyard may pass there through to secure the tool 201 to a user. Any object may pass through eyelet 204 as long as it is sized accordingly.

Scraper body 207 is formed at the tip of shaft 205 along an edge 219. As seen in FIG. 5, body 207 has a generally rectangular shape equal to that of shaft 105. Body 207 is the portion of shaft 205 above the connection point of removal member 208. Body 207 may be made from a material equal to or different from that of shaft 205. Body 207 includes a width and a thickness similar to that of shaft 205. The width of body 207 extends in the same planar direction of shaft 205. The width being equal to that of shaft 205 and is sized such that the width of body 207 is within the width of handle 203. Body 207 is coupled to the second end 211 of shaft 205 and may have a thickness and/or width larger than the thickness or width of shaft 205 in some embodiments. Scraper body 207 includes a scraper blade 217 along top edge 219. Blade 217 may be a tapered edge treatment. In this embodiment, blade 217 extends the full width of body 207.

It is understood that the material composition of scraper blade 217 may be the same or dissimilar to that of body 207. Additionally, the material composition of body 207 may be similar to or dissimilar from that of shaft 205. Whereas shaft 205 is designed and shaped to permit flexure to some extent, body 207 and blade 217 are configured to resist flexure. The flexure of shaft 205 can help with the prevention of marring of the pipe flange gasket surfaces. It is understood that blade 217 could be a coating or inlaid material across body 207 or within portions of body 207. Body 207 may include one or more blades along other edges and surfaces as desired. Such blades are similar in form and function to blade 217.

As seen most clearly in FIG. 6, removal member 208 is configured to extend out and away from shaft 205 and run parallel thereto. Member 208 transitions off a surface of shaft 205 and bends around such that member 208 is directed back toward handle 203 to permit a user to insert tool 201 into the slot 221. Tool 201 is inserted between the pipes, hooks the gasket, and is pulled back so as to pull the gasket out. The gasket is to pass between the slot 221 between shaft 205 and removal member 208. Member 208 may be made from the same material and have the same corresponding width and thickness as seen in the figures. It is understood that the thickness and width may differ from shaft 205 as desired. Also, the tip 218 of member 208 may be contoured with a curvature as opposed to the block rectangular shape.

Referring now also to FIG. 7 in the drawings, a side view of pipes 401 are shown positioned against each other, end to end. Gasket 403 is located between the pipes 401. Each pipe has a protruding ring section 407 adjacent the hollowed center 405. In operation, the fasteners are removed and wedges are used to separate the ends from one another. Tool 101/201 is inserted between pipes 401 and remove the old gasket. During removal, section 407 must be cleaned to remove the old gasket. Tool 101/201 may be passed between pipes 401 to hook the old gasket and use a blade to scrape the surface clean. No fingers or hands are required to pass between pipes 401.

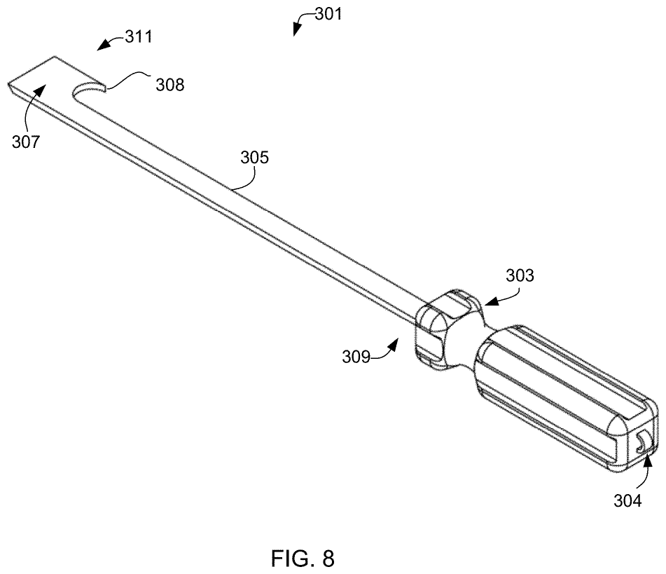

Referring now also to FIGS. 8-10 in the drawings, an alternative embodiment of tool 101 is illustrated wherein the shaft, scraper body and removal member are in the same plane. As seen in tools 101 and 201, the removal members were parallel to the shaft but were in different planes. In those embodiments, the removal member was stacked across the front face of the shaft thereby making the tool thicker at the portion that included the removal member. Flange gasket scraper tool 301 is similar in form and function to that of tools 101/201 but is different in that the shaft, scraper body, and removal member are integrally formed together and are defined in the same plane thereby making the thickness of the shaft consistent along the length of the tool (minus the handle). Tool 301 includes a handle 303, a shaft 305, a scraper body 307, and a removal member 308.

Handle 303 is configured to provide a user a place to grip and position scraper body 307 and removal member 308. Handle 303 is configured to include any one of a number of grips, grooves, curves, and textures to increase comfort and control of the tool in general. Handle 303 may be made from any known material and is configured to support shaft 305. Shaft 305 includes a first end 309 and a second end 311. First end 309 is coupled to handle 303. The second end 311 is adjacent to scraper body 307 and removal member 308. As seen in the figures, shaft 305 includes a narrowed section that is generally rectangular in shape, such that it has a thickness and a width. The thickness is smaller than the width. The drastic difference in the width compared to the thickness allows shaft 305 to flex about its width as seen in arrows 313 of FIG. 10, such that shaft 305 bends relative to a central axis 315. This flexure helps the user locate various surfaces within the pipe. It is understood that shaft 305 may include multiple contours and shapes along its length. It is preferred that shaft 305 include at least one area that allows flexure such that scraper body 307 and removal member 308 can alter its orientation relative to handle 303 during use.

Handle 303 also includes an eyelet 304 located on an end opposite that of shaft 305. Eyelet 304 is configured to permit a user to pass an object between itself and a bottom surface of handle 303 to enable tool 301 to be secured to a person or object. For example, a lanyard may pass there through to secure the tool 301 to a user. Any object may pass through eyelet 304 as long as it is sized accordingly.

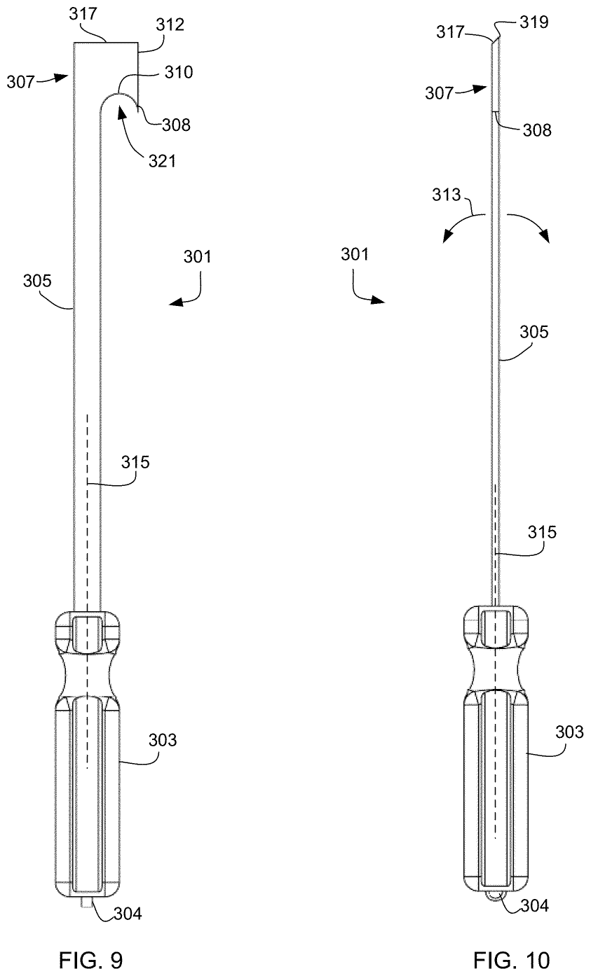

Scraper body 107 is formed in a generally rectangular shape as seen in FIG. 9 from the side. In the front view of FIG. 2, that general rectangular shape is maintained. Body 307 includes a thickness similar to that of shaft 305. The width of body 107 extends in the same planar direction of shaft 105. Naturally, the width is larger/wider than the width of shaft 305 and is sized such that the width of body 307 exceeds the width of the handle 303 in at least one direction from central axis 315. Body 307 is coupled to the second end 311 of shaft 305 and may have a thickness larger than the thickness of shaft 305. Scraper body 307 includes a scraper blade 317 along a top edge 319. As seen in FIG. 10, blade 317 is tapered at the edge 319 such that the thickness of blade 317 increases as it extends from edge 319 toward handle 303. In this embodiment, blade 317 extends the full width of body 307 which is also wider than the width of shaft 305.

It is understood that the material composition of scraper blade 317 may be the same or dissimilar to that of body 307. Additionally, the material composition of body 307 may be similar to or dissimilar from that of shaft 305. Whereas shaft 105 is designed and shaped to permit flexure to some extent, body 307 and blade 317 are configured to resist flexure. The flexure of shaft 305 can help with the prevention of marring of the pipe flange gasket surfaces. It is understood that blade 317 could be a coating or inlaid material across body 307 or within portions of body 307. Body 307 may include one or more blades along other edges and surfaces as desired. Such blades are similar in form and function to blade 317.

Removal member 308 extends below a bottom surface 310 of body 307 such that it extends downward toward handle 303 below surface 310. Member 208 may include a blade portion along its lowest surface and/or along its front surface which is aligned with surface 312. By being aligned with front surface 312, member 308 is actually located outside the width of handle 303.

As seen most clearly in FIG. 9, removal member 208 is configured to extend out and away from shaft 205 and run parallel thereto. Member 208 is formed by extending the length of surface 312 to be longer or taller than body 307. By extending the length of front surface 312 downward, removal member 308 is formed and extends toward handle 303. A gap or slot 321 is formed between member 308 and shaft 305. This design affords the user the advantage of maintaining minimal thickness while maintaining the ability for the user to insert tool 301 between the pipes, then hook the gasket, and pull it back so as to pull the gasket out. The gasket is to pass between the slot 321 between shaft 205 and removal member 208. During use, the user may rotate the tool 90 degrees about axis 315 once within the gap between the pipes as body 307 is wider than shaft 305. This allows member 308 to pass through the gasket to permit it to be pulled out. It is understood that an optimal method of manufacturing tool 301 would be to stamp shaft 305, body 307, and member 308 from a single piece of material. However, each may be of dissimilar materials and coupled together if needed or chosen in other embodiments.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A flange gasket scraper tool, comprising:
a handle;
a shaft having a first end and a second end, the first end being coupled to the handle, the shaft having a width and a thickness being rectangular in shape, the shaft configured to flex about its width;
a scraper body coupled to the second end of the shaft, the scraper body having a width and a thickness, the scraper body width being equal to the width of the shaft, the scraper body including a scraper blade along a top edge of the scraper body; and
a removal member coupled to the shaft and extending downward to the handle.

2. The tool of claim 1, wherein the scraper body is tapered so as to have a triangular profile.

3. The tool of claim 2, wherein the removal member is in communication with the scraper body.

4. The tool of claim 2, wherein the scraper body extends over the removal member.

5. The tool of claim 1, wherein a slot is formed between the removal member and the shaft.

6. The tool of claim 1, further comprising an eyelet coupled to the shaft.

7. The tool of claim 1, wherein the scraper blade extends the full width of the scraper body.

8. The tool of claim 1, wherein the scraper body has a thickness equal to the thickness of the shaft.

9. The tool of claim 1, wherein the scraper blade has edges formed at right angles.

10. The tool of claim 1, wherein the scraper blade has a tapered edge.

11. The tool of claim 1, wherein the removal member is parallel to the shaft.

12. The tool of claim 1, wherein the scraper blade is an edge treatment.

13. The tool of claim 1, wherein the shaft and the scraper body are made of dissimilar materials.

14. The tool of claim 1, wherein the removal member and the shaft are made of dissimilar materials.

15. The tool of claim 1, wherein the removal member is coupled to a face of the shaft.

16. The tool of claim 1, wherein the width of the scraper body is wider than the width of the shaft.

17. The tool of claim 1, wherein the scraper body, the shaft, and the removal member are in the same plane.
